(19) United States
(12) Patent Application Publication
(10) Pub. No.: US 2015/0146928 A1
(43) Pub. Date: May 28, 2015

(54) APPARATUS AND METHOD FOR TRACKING MOTION BASED ON HYBRID CAMERA

(71) Applicant: ELECTRONICS AND TELECOMMUNICATIONS RESEARCH INSTITUTE, Daejeon (KR)

(72) Inventors: Jong Sung KIM, Daejeon (KR); Myung Gyu KIM, Daejeon (KR); Seong Min BAEK, Daejeon (KR); Ye Jin KIM, Daejeon (KR); Il Kwon JEONG, Daejeon (KR)

(21) Appl. No.: 14/554,365

(22) Filed: Nov. 26, 2014

(30) Foreign Application Priority Data
Nov. 27, 2013 (KR) 10-2013-0145656
Jul. 4, 2014 (KR) 10-2014-0083916

(51) Int. Cl. G06K 9/00; G06T 7/00; G06T 15/10; G06T 11/60

(52) U.S. Cl. CPC G06K 9/00624; G06K 9/00369; G06T 11/60; G06T 7/0071; G06T 15/10
USPC 382/103

(57) ABSTRACT

An apparatus and method for tracing a motion of an object using high-resolution image data and low-resolution depth data acquired by a hybrid camera in a motion analysis system used for tracking a motion of a human being. The apparatus includes a data collecting part, a data fusion part, a data partitioning part, a correspondence point tracking part, and a joint tracking part. Accordingly, it is possible to precisely track a motion of the object by fusing the high-resolution image data and the low-resolution depth data, which are acquired by the hybrid camera.

### CROSS-REFERENCE TO RELATED APPLICATION(S)

This application claims priority from Korean Patent Application Nos. 10-2013-0145656, filed on Nov. 27, 2013, and 10-2014-0083916, filed on Jul. 4, 2014, in the Korean Intellectual Property Office, the disclosures of which are incorporated herein by reference in its entirety.

### BACKGROUND

1. Field

The following description relates to an apparatus and method for tracking a motion of an object using high-resolution image data and low-resolution depth data acquired by a hybrid camera in a motion analysis system to track a motion of a human being as an object.

2. Description of the Related Art

Generally, a motion tracking technology is used to track motions of a person, such as an actor/actress, an athlete, a solder, or the like for character animation, special effects, analysis of exercise, military training, and so forth in various industrial fields including animation, games, movies, sport, medical, and military fields.

As a traditional motion tracking technology, there is a camera-based method by which a motion of an object is tracked by matching image data obtained by a number of high-resolution cameras with a previously offered 3-dimensional appearance model of an object, or by simultaneously restoring a 3D appearance model and matching the 3D appearance model with the image data obtained by the high-resolution cameras, and there is a sensor-based method by an object's motion is tracked by recognizing a position of each joint of the object from low-resolution depth data obtained by one depth sensor.

However, the camera-based method needs to modify or restore the object appearance model in a 3D space, whereas the sensor-based method does not require additional restoration of the object's appearance model, but has limited motion-tracking performance due to the use of depth data.

### SUMMARY

The following description relates to an apparatus and method for precisely tracking a motion of an object for hybrid camera-based motion analysis, by combining high-resolution image data and low-resolution depth data, which are obtained by a hybrid camera including a high-resolution image camera and a low-resolution depth sensor, without restoring the full figure of the object using the high-resolution camera or without recognizing joints of the object using the low-resolution depth sensor.

In one general aspect, there is provided An apparatus for tracking a motion using a hybrid camera, the apparatus including: a data collecting part configured to obtain high-resolution image data and low-resolution depth data of an object; a data fusion part configured to warp the obtained low-resolution depth data to the same image plane as that of the high-resolution image data, and fuse the high-resolution image data with high-resolution depth data upsampled from the low-resolution depth data on a pixel-by-pixel basis to produce high-resolution fused data; a data partitioning part configured to partition the high-resolution fused data by pixel and distinguish between object pixels and background pixels, wherein the object pixels represent the object and the background pixels represent a background of an object image, and partition all object pixels into object-part groups using depth values of the object pixels; a correspondence point tracking part configured to track a correspondence point between a current frame and a subsequent frame of the object pixel; and a joint tracking part configured to track a 3-dimensional (3D) position and angle of each joint of a skeletal model of the object, in consideration of a hierarchical structure and kinematic chain of the skeletal model, by using received depth information of the object pixels, information about an object part, and correspondence point information.

The data collecting part may use one high-resolution image information collecting device to obtain the high-resolution image data, and one low-resolution image information collecting device to obtain the low-resolution depth data.

The data fusion part may include: a depth value calculator configured to convert depth data of the object into a 3D coordinate value using intrinsic and extrinsic parameters contained in the obtained high-resolution image data and low-resolution depth data, project the 3D coordinate value onto an image plane, calculate a depth value of a corresponding pixel on the image plane based on the projected 3D coordinate value, and when an object pixel lacks a calculated depth value, calculate a depth value of the object pixel through warping or interpolation, so as to obtain a depth value of each pixel; an up-sampler configured to designate the calculated depth value to each pixel on an image plane and upsample the low-resolution depth data to the high-resolution depth data using joint-bilateral filtering that takes into consideration a brightness value of the high-resolution image data and distances between the pixels, wherein the upsampled high-resolution depth data has the same resolution and projection relationship as those of the high-resolution image data; and a fused data generator configured to fuse the upsampled high-resolution depth data with the high-resolution image data to produce the high-resolution fused data.

The depth value calculator may include: a 3D coordinate value converter configured to convert the depth data of the object into the 3D coordinate value using the intrinsic and extrinsic parameters contained in the high-resolution image data; an image plane projector configured to project a 3D coordinate value of a depth data pixel onto an image plane of an image sensor by applying 3D perspective projection using intrinsic and extrinsic parameters of the low-resolution depth data; and a pixel depth value calculator configured to convert the projected 3D coordinate value into the depth value of the corresponding image plane pixel based on a 3D perspective projection relationship, and when an image plane pixel among image pixels representing the object lacks a depth value, calculate a depth value of the image plane pixel through warping or interpolation.

The pixel depth value calculator may include: a converter configured to convert the projected 3D coordinate value into the depth value of the corresponding image plane pixel based on the 3D perspective projection relationship of the image sensor; a warping part configured to, when the image plane pixel among the image pixels lacks a depth value, calculate the depth value of the image plane pixel through warping; and an interpolator configured to calculate a depth value of a non-warped pixel by collecting depth values of four or more peripheral pixels around the non-warped pixel and compute an approximate value of the depth value of the non-warped pixel through interpolation.

The data partitioning part may divide the produced high-resolution fused data by pixel, distinguishes between the object pixels and the background pixels from the high-resolution fused data, calculate a shortest distance from each object pixel to a bone that connects joints of the skeletal model of the object by using depth values of the object pixels, and partition all object pixels into different body part groups based on the calculated shortest distance.

The data partitioning part may partition the object pixels and the background pixels into different object part groups by numerically or statistically analyzing a difference in image value between the object and the background pixels, numerically or statistically analyzing a difference in depth value between the object and the background pixels, or numerically or statistically analyzing difference in both image value and depth value between the object and the background pixel.

In another general aspect, there is provided a method for tracking a motion using a hybrid camera, the method including: obtaining high-resolution image data and low-resolution depth data of an object; warping the obtained low-resolution depth data to the same image plane to as that of the high-resolution image data, and fusing the high-resolution image data with high-resolution depth data upsampled from the low-resolution depth data on a pixel-by-pixel basis to produce high-resolution fused data; partitioning the high-resolution fused data by pixel and distinguishing between object pixels and background pixels wherein the object pixels represent the object and the background pixels represent a background of an object image, and partitioning all object pixels into object-part groups using depth values of the object pixels; tracking a correspondence point between a current frame and a subsequent frame of the object pixel; and tracking a 3-dimensional (3D) position and angle of each joint of a skeletal model of the object, in consideration of a hierarchical structure and kinematic chain of the skeletal model, by using received depth information of the object pixels, information about an object part, and correspondence point information.

The obtaining of the high-resolution image data and the low-resolution depth data may include obtaining the high-resolution image data and the low-resolution depth data using one high-resolution image information collecting device and one low-resolution depth information collecting device, respectively.

The producing of the high-resolution fused data may include: converting depth data of the object into a 3D coordinate value using intrinsic and extrinsic parameters contained in the obtained high-resolution image data and low-resolution depth data, projecting the 3D coordinate value onto an image plane, calculating a depth value of a corresponding pixel on the image plane based on the projected 3D coordinate value, and when an object pixel lacks a calculated depth value, calculating a depth value of the object pixel through warping or interpolation, so as to obtain a depth value of each pixel; designating the calculated depth value to each pixel on an image plane and upsampling the low-resolution depth data to the high-resolution depth data using joint-bilateral filtering that takes into consideration a brightness value of the high-resolution image data and distances between the pixels, wherein the upsampled high-resolution depth data has the same resolution and projection relationship as those of the high-resolution image data; and fusing the upsampled high-resolution depth data with the high-resolution image data to produce the high-resolution fused data.

The calculating of the depth value of the pixel may include: converting the depth data of the object into the 3D coordinate value using the intrinsic and extrinsic parameters contained in the high-resolution image data; projecting a 3D coordinate value of a depth data pixel onto an image plane of an image sensor by applying 3D perspective projection using intrinsic and extrinsic parameters of the low-resolution depth data; and converting the projected 3D coordinate value into a depth value of the corresponding image plane pixel based on a 3D perspective projection relationship, and when an image plane pixel among image pixels representing the object lacks a depth value, calculating a depth value of the image plane pixel through warping or interpolation.

The calculating of the depth value of the pixel may include: converting the projected 3D coordinate value into the depth value of the corresponding image plane pixel based on the 3D perspective projection relationship of the image sensor; when the image plane pixel among the image pixels lacks a depth value, calculating the depth value of the image plane pixel through warping; and calculating a depth value of a non-warped pixel by collecting depth values of four or more peripheral pixels around the non-warped pixel and computing an approximate value of the depth value of the non-warped pixel through interpolation.

The partitioning of the pixels into the different body part groups may include dividing the produced high-resolution fused data by pixel, distinguishing between the object pixels and the background pixels from the high-resolution fused data, calculating a shortest distance from each object pixel to a bone that connects joints of the skeletal model of the object by using depth values of the object pixels, and partitioning all object pixels into different body part groups based on the calculated shortest distance.

The partitioning of the pixels into the different body part groups may include partitioning the object pixels and the background pixels into different object part groups by numerically or statistically analyzing a difference in image value between the object and the background pixels, numerically or statistically analyzing a difference in depth value between the object and the background pixels, or numerically or statistically analyzing difference in both image value and depth value between the object and the background pixel.

Other features and aspects will be apparent from the following detailed description, the drawings, and the claims.

### BRIEF DESCRIPTION OF THE DRAWINGS

FIG. 1 is a diagram illustrating an apparatus for tracking a motion using a hybrid camera according to an exemplary embodiment.

FIG. 2 is a diagram illustrating a configuration of the data fusion part shown in FIG. 1.

FIG. 3 is a diagram illustrating a configuration of a depth value calculator shown in FIG. 2.

FIG. 4 is a diagram illustrating a configuration of the pixel depth value calculator shown in FIG. 3.

FIG. 5 is a diagram showing a data flow for precisely tracking a motion of an object based on high-resolution image data and low-resolution depth data in a hybrid camera-based motion tracking apparatus according to an exemplary embodiment.

FIG. 6 is a diagram illustrating a hierarchical structure of an object skeletal model that is used to partition pixels according to an object body part and track a position and angle of each joint in a hybrid camera-based motion tracking apparatus in accordance with an exemplary embodiment.

FIG. 7 is a diagram showing the application of an object skeletal model structure to the object using a hybrid camera-based motion tracking apparatus in accordance with an exemplary embodiment.

FIG. 8 is a diagram illustrating pixel groups of each part of an object that are created based on the shortest distance from a 3D point that corresponds to a high-resolution depth data pixel to a bone that connects joints of the object skeletal model used for a hybrid camera-based motion tracking apparatus in accordance with an exemplary embodiment.

FIG. 9 is a flowchart illustrating a method of tracking a motion using a hybrid camera according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

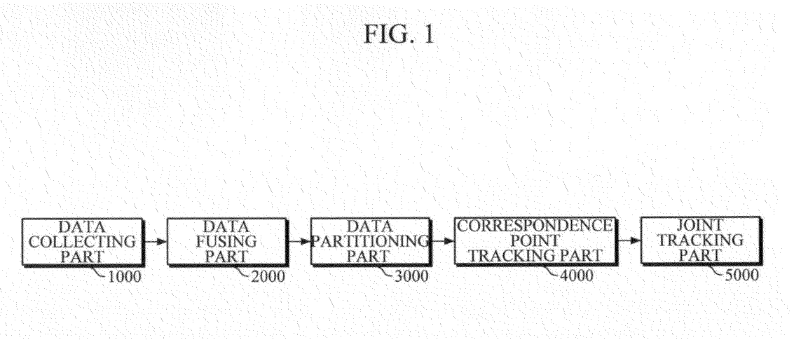

FIG. 1 is a diagram illustrating an apparatus for tracking a motion using a hybrid camera according to an exemplary embodiment.

Referring to FIG. 1, the apparatus 100 may include a data collecting part 1000, a data fusing part 2000, a data partitioning part 3000, a correspondence point tracking part 4000, and a joint tracking part 5000.

The data collecting part 1000 may collect high-resolution image data and low-resolution depth data using a high resolution camera and a low-resolution depth sensor, respectively.

In one example, the apparatus 100 may collect high-resolution image data and low-resolution depth data of a human being as a target object using one high-resolution camera and one low-resolution depth sensor which are included in a hybrid camera, in order to track motions of the target object, such as an actor or actress, a patient, a soldier, or the like for character animation, special effects, analysis of exercise, military training, etc.

The data fusion part 2000 may warp the low-resolution depth data on the same image plane as the high-resolution image data using received data, and fuse high-resolution depth data upsampled from the low-resolution depth data with the high-resolution image data on a pixel-by-pixel basis to yield high-resolution fused data.

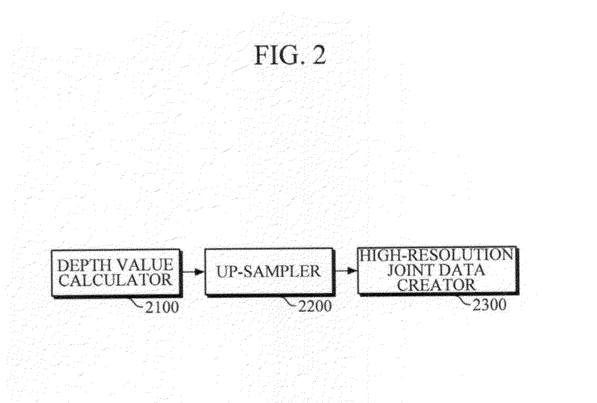

The data fusion part 2000 will be described in detail with reference to FIG. 2.

The data partitioning part 3000 may divide the produced high-resolution fused data by pixel, distinguish pixels (hereinafter, referred to as “object pixels”) that represent an object from pixels (hereinafter, referred to as “background pixels”) that represent background, and then classify the object pixels into different body part groups using depth values of the object pixels.

In the example, in order to classify all object pixels into different body part groups, the apparatus 100 may distinguish between the object pixels and the background pixels from the high-resolution fused data, calculate a shortest distance from each object pixel to a bone that connects joints of a skeletal model of the object by using depth values of the object pixels, and partition all object pixels into different body part groups based on the calculated shortest distance.

In one example, to distinguish between the object pixels and the background pixels, the apparatus 100 may use a method of numerically or probabilistically analyzing a difference in image value (brightness value or color value) between the object pixels and the background pixels. However, the aspects of the present disclosure are not limited thereto, such that the apparatus 100 may use a method of numerically or probabilistically analyzing a difference in depth value between the object pixels and the background pixels and partitioning the object pixels and the background pixels or a method of numerically or probabilistically analyzing the differences in both image value and depth value.

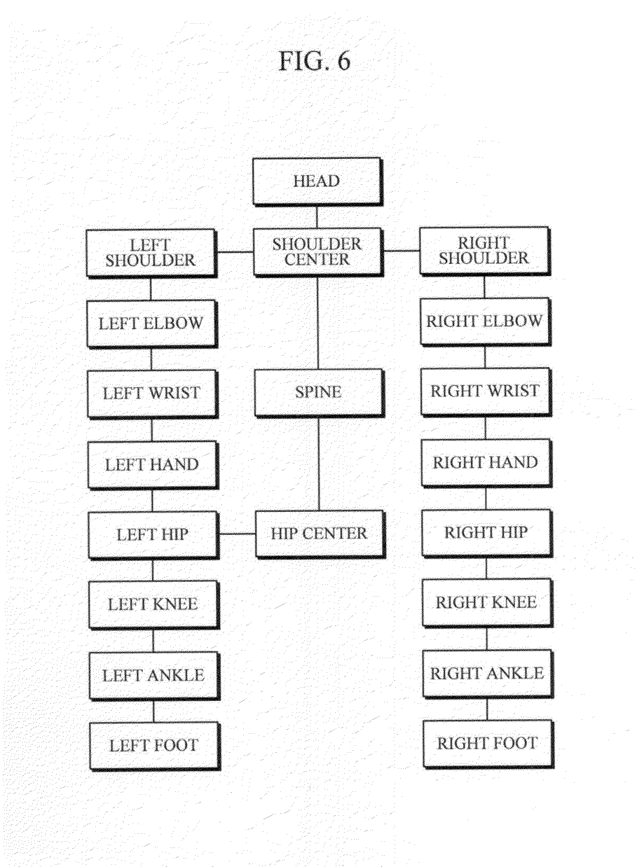

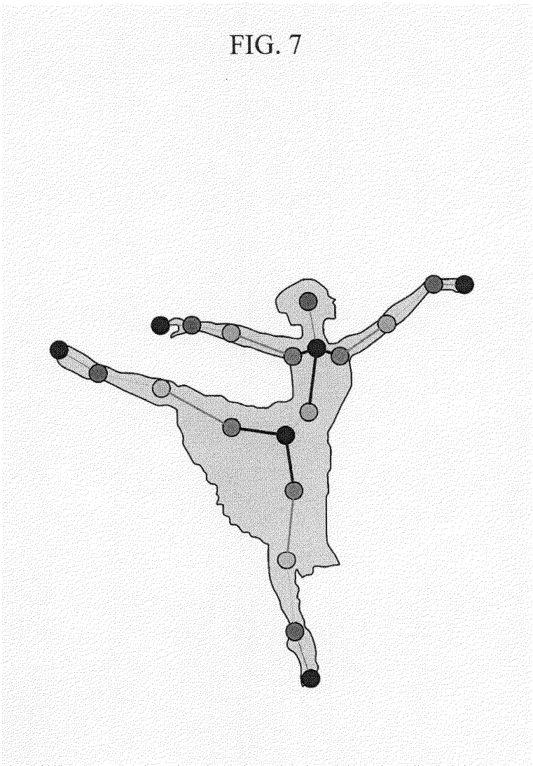

The skeletal model of the object will be described in detail with reference to FIG. 6 and FIG. 7.

From the high-resolution fused data, the partitioning of the object pixels into corresponding body part groups may be performed by calculating a three-dimensional (3D) position X_{I} of each object pixel using a corresponding depth value, and a shortest distance l_{I}^{i,i+1} from the calculated 3D position X_{I} to a bone connecting an i-th joint Jᵢ and an (i+1)th joint Jᵢ₊₁ of an object skeletal model, as shown in FIG. 7, is calculated by Equation 1.

$${l}_{I}^{i , i + 1} = \frac{\sqrt{{‖ ( \text{?} - {X}_{{J}_{i + 1}} ) \times ( {X}_{I} - \text{?} ) ‖}^{2}}}{\sqrt{{‖ {X}_{{J}_{i + 1}} - {X}_{{j}_{i}} ‖}^{2}}} , \\ \text{?} \text{indicates text missing or illegible when filed} \qquad ( 1 )$$

where Xⱼ [symbol] represents 3D coordinates of joint Jᵢ, and X_{J}_{ᵢ₊₁} represents 3-dimensional coordinates of joint Jᵢ₊₁. X_{I} which represents a 3D coordinate vector of an object pixel may be calculated by applying a calibration matrix Kᵢ of a high-resolution image sensor and a corresponding high-resolution depth data value dₕ(x_{I}) to Equation 2 as below.

X_{I}=dₕ(x_{I})K_{I}⁻¹x_{I} (2)

After the shortest distances from each of the object pixels to each bone are calculated using the above equations, the object pixel is allocated to an area corresponding to a bone with the minimum value of the shortest distance, and in this manner, all object pixels may be classified into corresponding body part groups.

In this case, if the minimum value of the shortest distance of a particular object pixel is greater than a particular threshold, the object pixel may be determined not to correspond to a skeletal part of the object.

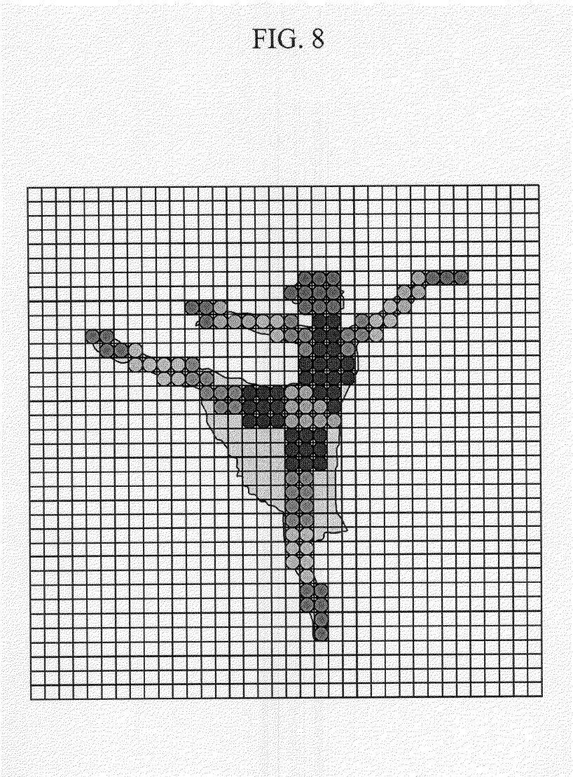

In this manner, all object pixels, other than object pixels representing clothing or the like of the object, may be partitioned into different skeletal part groups, as shown in FIG. 8.

The correspondence point tracking part 4000 may track a correspondence point between a current frame and a subsequent frame of an object pixel, by using constraints of constancy of image value.

In one example, the tracking of a correspondence point may be performed by using Equation 3 to calculate a correspondence point x_{I}^{t+1} on a subsequent frame I^{t+1} of an object pixel that minimizes a difference in image value, wherein the object pixel is located at position x_{I}^{t} on a current frame I^{t}.

$$min \frac{1}{2} {‖ {I}^{t} ( {x}_{I}^{t} ) - {I}^{t - 1} ( {x}_{I}^{t + 1} ) ‖}^{2} \qquad ( 3 )$$

The joint tracking part 5000 may receive depth information of an object pixel and area information of the object, and correspondence point information, and track a 3D position and angle of each joint of the object skeletal model by taking into consideration a hierarchical structure and kinematic chain of the skeletal model.

In one example, 3D position X_{I}^{t,i} of a pixel allocated to an i-th area of a current frame may correspond to 3D position X_{I}^{t+1,i} on a subsequent frame which may be based on a motion of joint Jᵢ in the i-th area and hierarchical structure and kinematic chain of the skeletal model. The 3D position X_{I}^{t+1,i} on the subsequent frame may be calculated by Equation 4 as below.

$${X}_{I}^{t + 1 , i} = {\prod }_{j = 0}^{i} \text{?} {X}_{I}^{i , j} \\ \text{?} \text{indicates text missing or illegible when filed} \qquad ( 4 )$$

Here, θⱼ represents a rotation value of joint Jᵢ, \hat{ξ}ⱼ represents 4×4 twist matrix of joint Jᵢ.

Joint position and angle parameters Λ=(θ₀ξ₀,θ₁, . . . , θ_{N-1}) that minimize a difference between 2D position x_{I}^{t+1} of a pixel on a subsequent frame and 2D position Ψ(X_{I}^{t+1}) of the pixel on an image plane onto which 3D position X_{I}^{t+1} of the pixel is projected are calculated using a twist motion model by Equation 5 for each of a total of N joints, so that the motion tracking can be performed.

$$min \frac{1}{2} \sum {‖ Ψ ( {X}_{I}^{t + 1} ) - {x}_{I}^{t + 1} ‖}^{2} \qquad ( 5 )$$

FIG. 2 is a diagram illustrating a configuration of the data fusion part shown in FIG. 1.

Referring to FIG. 2, the data fusion part 2000 may include a depth value calculator 2100, an up-sampler 2200, and a high-resolution joint data creator 2300.

The depth value calculator 2100 may transform depth data of an object pixel into a 3D coordinate value using received image data and an intrinsic parameter and extrinsic parameter of depth data. The depth value calculator 2100 may project the transformed 3D coordinate value onto an image plane, and calculate a depth value of a pixel on the image plane based on the projected 3D coordinate value. In a case where an object pixel lacks a calculated depth value, the depth value calculator 2100 may calculate a depth value of the pixel through warping or interpolation, thereby being able to calculate depth values of all pixels.

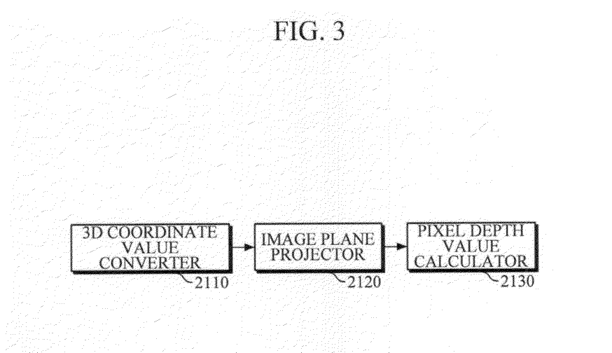

The depth-value calculator 2100 will be described in detail with reference to FIG. 3.

The up-sampler 2200 may designate the calculated depth value of the pixel to each, pixel to on a high-resolution image plane, and upsample low-resolution depth data to high-resolution depth data using a joint-bilateral filter that takes into account a brightness value of high-resolution image data and a distance between pixels, wherein the high-resolution depth data has the same resolution and projection relationship as those of the high-resolution image data.

In one example, the joint-bilateral filtering may be implemented by Equation 5.

$${d}_{h} ( {x}_{I} ) = \frac{\text{?} w ( {x}_{I} , \text{?} ) {d}_{h} ( \text{?} )}{\text{?} w ( {x}_{I} , \text{?} )} \\ \text{?} \text{indicates text missing or illegible when filed} \qquad ( 5 )$$

Here, dₕ(x_{I}) represents a depth value of a pixel at 2D coordinates x_{I} on the high-resolution image plane, y_{I} represents 2D coordinates of a pixel belonging to a peripheral area N of the pixel at x_{I}, and w(x_{I}, [symbol] _{I}) represents a joint-bilateral weight that can be calculated by Equation 6.

$$w ( {x}_{I} , \text{?} ) = \text{?} \text{?} \\ \text{?} \text{indicates text missing or illegible when filed} \qquad ( 6 )$$

Here, σ_{S} represents a standard deviation of a distance value from a pixel at x_{I} to an arbitrary pixel at [symbol] within a peripheral area of the pixel at x_{I}, σ_{D} [symbol] represents a standard deviation of a difference value between an image data value I(x_{I}) of the pixel at x_{I} and an image data value I(y_{I}) of the pixel at y_{I}. As described above, the joint-bilateral filtering may allow the edge of the depth data to become identical to that of the image data and be locally regularized.

Thus, edge information of the high-resolution image data can be taken into account in upsampling the low-resolution depth data to high-resolution depth data.

The high-resolution bilateral data generator 2300 may upsample the low-resolution depth data to high-resolution depth data that has the same resolution and projection relationship as those of the high-resolution image data, and may fuse the upsampled high-resolution depth data with the high-resolution image data to yield high-resolution fused data.

FIG. 3 is a diagram illustrating a configuration of a depth value calculator shown in FIG. 2.

Referring to FIG. 3, the depth value calculator 2100 may include a 3D coordinate value converter 2110, an image plane projector 2120, and a pixel depth value calculator 2130.

The 3D coordinate value converter 2110 may convert a depth value of a depth data pixel of the object into a 3D coordinate value by inversely applying 3D perspective projection ψ of a depth sensor which is represented by intrinsic and extrinsic parameters of the depth sensor.

In one example, the intrinsic parameters may include a focal length, an optical center and aspect ratio parameters of each lens used for the image camera and the depth sensor.

The extrinsic parameters may include orientation and position parameters of the image and depth sensors in a 3D space.

The image plane projector 2120 may project the 3D coordinate value of the depth data pixel on an image plane of the image sensor by applying the 3D perspective projection of the image sensor which is represented by intrinsic and extrinsic parameters of the image camera.

The pixel depth value calculator 2130 may convert the projected 3D coordinates into a depth value of the corresponding image plane pixel based on a 3D perspective projection relationship of the image sensor, and when an image plane pixel of the object lacks a depth value, may calculate a depth value of the image plane pixel by warping or interpolation.

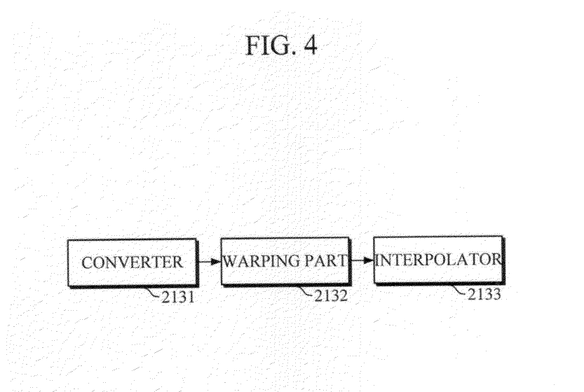

The pixel depth value calculator 2130 will be described in detail with reference to FIG. 4.

FIG. 4 is a diagram illustrating a configuration of the pixel depth value calculator shown in FIG. 3.

Referring to FIG. 4, the pixel depth value calculator 2130 may include a converter 2131, a warping part 2132, and an interpolator 2133.

The converter 2131 may convert the projected 3D coordinates into a depth value of the corresponding image plane pixel based on the 3D perspective projection relationship of the image sensor.

The warping part 2131 may calculate a depth value of an image plane pixel by warping when the image plane pixel among object image pixels lacks a depth value.

According to an exemplary embodiment, warping may be performed using Equation 7.

x_{I}=K_{I}R_{I}(R_{I}⁻¹X_{D}−t_{D})+K_{I}t_{I} (7)

Here, X_{D} denotes a 3×1 vector that represents 3D coordinates corresponding to a depth value of a depth data pixel, R_{D} denotes a 3×3 matrix that represents a 3D orientation parameter of the depth sensor, t_{D} denotes a 3×1 vector that represents a 3D position of the depth sensor, K_{I} denotes a 3×3 matrix that represents intrinsic and extrinsic correction parameters of the image sensor, R_{I} denotes a 3×3 matrix that represents 3D orientation of the image sensor, t_{I} denotes a 3×1 vector that represents 3D position of the depth sensor, and X_{I} denotes a 3×1 vector that represents 2D coordinates on the image plane of an image sensor that corresponds to X_{D}.

3D coordinate vector X_{D} that corresponds to d_{I}(x_{D}) which is a depth value of the depth data pixel at 2D coordinates X_{D} from the depth data may be calculated by Equation 8 using 3×3 matrix K_{D} that represents intrinsic and extrinsic parameters of the depth sensor.

X_{D}=d_{I}(x_{D})K_{D}⁻¹x_{D} (8)

The interpolator 2133 may calculate a depth value of a non-warped pixel by collecting depth values of four or more peripheral pixels around the non-warped pixel and computing an approximate value of the depth value of the non-warped pixel through interpolation.

In one example, in the case of a pixel whose depth value is not warped, an approximate value of the depth value of the pixel may be computed by interpolation on depth values of four or more peripheral pixels.

After a depth value of each pixel on the high-resolution image plane is all designated by the above calculation, high-resolution depth data may be obtained from the low-resolution depth data through joint bilateral filtering that takes into account a brightness value of image data and a distance between pixels.

Here, the joint bilateral filtering may be implemented by Equation 9.

$${d}_{h} ( {x}_{I} ) = \frac{\text{?} w ( {x}_{I} , \text{?} ) {d}_{h} ( \text{?} )}{\text{?} w ( {x}_{I} , \text{?} )} \\ \text{?} \text{indicates text missing or illegible when filed} \qquad ( 9 )$$

Here, dₕ(x_{I}) denotes a depth value of a pixel at 2D coordinates x_{I} on the high-resolution image plane, y_{I} denotes 2D coordinates of a pixel within a peripheral area N of a pixel at x_{I}, and w(x_{I},y_{I}) denotes a joint-bilateral weight that may be calculated using Equation 10 below.

$$w ( {x}_{I} , \text{?} ) = \text{?} \text{?} \\ \text{?} \text{indicates text missing or illegible when filed} \qquad ( 10 )$$

Here, σ_{S} represents a standard deviation of a distance value from a pixel at x_{I} to an arbitrary pixel at [symbol] within a peripheral area of the pixel at x_{I}, σ_{D} [symbol] represents a standard deviation of a difference value between an image data value I(x_{I}) of the pixel at x_{I} and an image data value I(y_{I}) of the pixel at y_{I}.

As described above, the joint-bilateral filtering may allow the edge of the depth data to become identical to that of the image data and also be locally regularized, so that data upsampling from low-resolution depth data to high-resolution depth data while taking into consideration edge information of the high-resolution image data.

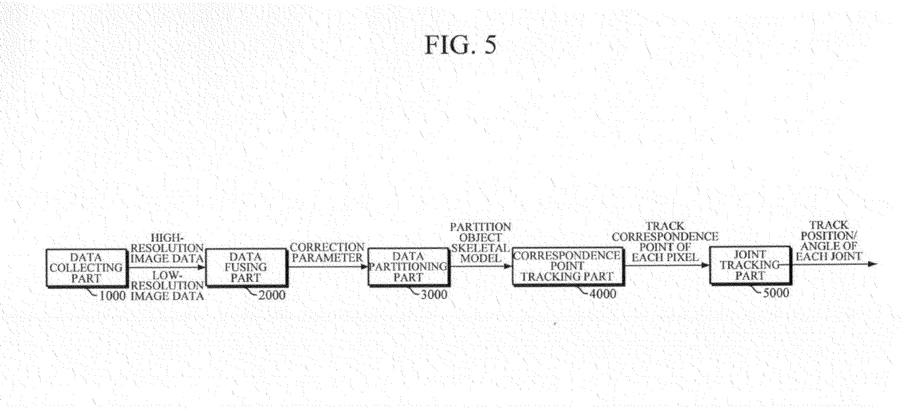

FIG. 5 is a diagram showing a data flow for precisely tracking a motion of an object based on high-resolution image data and low-resolution depth data in a hybrid camera-based motion tracking apparatus according to an exemplary embodiment.

Referring to FIG. 5, high-resolution image data may be collected by a high resolution image camera and low-resolution depth data may be collected by a depth sensor.

A depth value of the object may be calculated using intrinsic and extrinsic correction parameters, and the low-resolution depth data may be upsampled to high-resolution depth data that has the same resolution and projection relationship as those of the high-resolution image data, and may fuse the upsampled high-resolution depth data and the high-resolution image data to yield high-resolution fused data.

The high-resolution fused data is distinguished between object pixels and background pixels, and then by using the depth values of the object pixels, the object pixels are classified into different body part groups based on a shortest distance from each object pixel to a bone that connects joints of a joint hierarchical structure of the object as shown in FIG. 6

In this case, the object pixels and background pixels may be distinguished therebetween using a method of numerical or statistical analysis of a difference in image value (for example, brightness value or color value) between object pixels and background pixels.

In addition, a difference in depth value between the object pixels and the background pixels may be either or both simultaneously numerically and statistically analyzed to distinguish between the object pixels and the background pixels.

In one example, a correspondence point between the current frame and the subsequent frame of an object pixel may be tracked using the high-resolution fused data that is partitioned by a body part of the object and the constraints of constancy of image value, and thereby result data may be generated.

In addition, the result data, the depth information of the object pixels, information about a part of the object, and correspondence point information may be received, a 3D position and angle of each joint of the object skeletal model may be tracked using the received information, in consideration of a hierarchical structure and kinematic chain of the object skeletal model, and data about tracking result may be generated.

The hierarchical structure of the object skeletal model will be described in detail with reference to FIG. 6.

FIG. 6 is a diagram illustrating a hierarchical structure of an object skeletal model that is used to partition pixels according to an object body part and track a position and angle of each joint in a hybrid camera-based motion tracking apparatus in accordance with an exemplary embodiment.

Referring to FIG. 6, the object joint hierarchical structure, which is used to partition pixels according to an object body part and track the position and angle of each joint, may include body part groups, such as head, shoulder center, left shoulder, left elbow, left wrist, left hand, right shoulder, right elbow, right wrist, right hand, spine, hip center, left hip, left knee, left ankle, left foot, right hip, right knee, right angle, right foot, and the like.

FIG. 7 is a diagram showing the application of an object skeletal model structure to the object using a hybrid camera-based motion tracking apparatus in accordance with an exemplary embodiment.

Referring to FIG. 7, it is shown that the hierarchical structure of the object skeletal model illustrated in FIG. 6 is applied to an actual object.

FIG. 8 is a diagram illustrating pixel groups of each part of an object that are created based on the shortest distance from a 3D point that corresponds to a high-resolution depth data pixel to a bone that connects joints of the object skeletal model used for a hybrid camera-based motion tracking apparatus in accordance with an exemplary embodiment.

Referring to FIG. 8, pixels of an actual object image to which the hierarchical structure of the object skeletal model shown in FIG. 7 is applied are grouped according to a body part based on the shortest distance from a 3D point that corresponds to a bone that connects joints of the object skeletal model.

The grouping of object pixels of the high-resolution fused data according to a body part of the object may be performed using Equation 1.

As described with reference to FIG. 1, the shortest distance from an object pixel to each bone may be calculated by Equation 1 and Equation 2, and all object pixels may be partitioned into their corresponding body part groups by allocating the pixels to an area of the object corresponding to a bone with the minimum value of the shortest distance.

In this manner, it is possible to partition all object pixels, other than the object pixels that represent clothing or the like, into skeletal parts of the object.

Through the partitioned pixel data, a correspondence point between a current frame and a subsequent frame of an object pixel may be tracked using photometric constraints, that is, constraints of constancy of image value, of the current frame and the subsequent frame of image data obtained by the high-resolution image sensor.

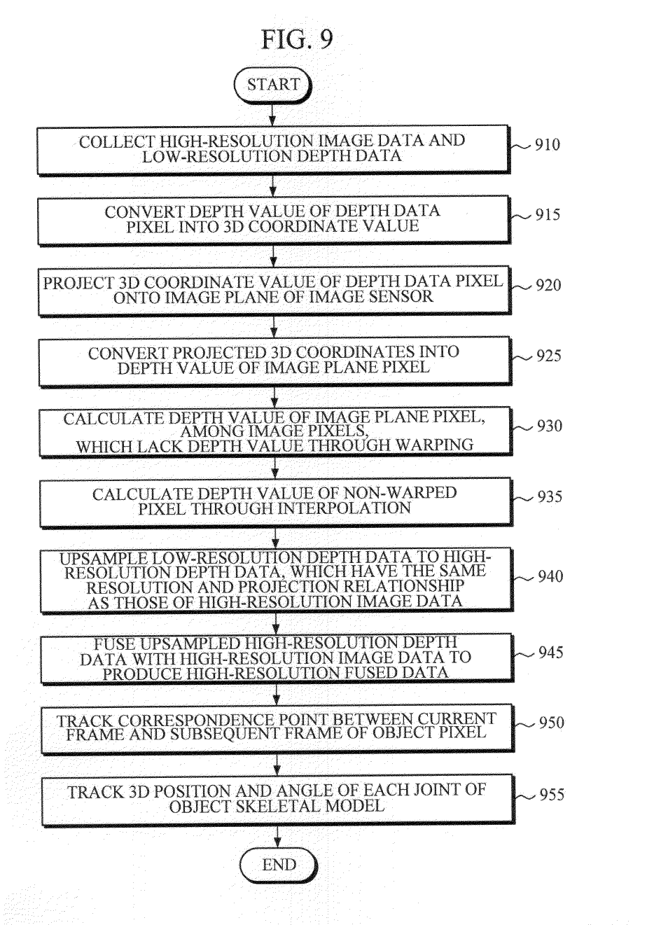

FIG. 9 is a flowchart illustrating a method of tracking a motion using a hybrid camera according to an exemplary embodiment.

High-resolution image data and low-resolution depth data are collected in 910.

In one example, the high-resolution image data may be collected by a high-resolution camera, and the low-resolution depth data may be collected by a low-resolution depth sensor.

In one example, in order to track a motion of an object, which is a human being, one high-resolution camera obtains high-resolution image data and one low-resolution depth sensor obtains low-resolution depth data.

A depth value of the depth data pixel is converted into a 3D coordinate value in 915.

In one example, a depth value of a depth data pixel of the object may be converted into a 3D coordinate value by inversely applying 3D perspective projection W of a depth sensor which is represented by intrinsic and extrinsic parameters of the depth sensor.

The 3D coordinate value of the depth data is projected onto an image plane of the image sensor in 920.

In one example, the 3D coordinate value of the depth data pixel may be projected onto the image plane of the image sensor by applying the 3D perspective projection of the image sensor which is represented by intrinsic and extrinsic parameters of the image sensor.

The projected 3D coordinates are converted into a depth value of the corresponding image plane pixel in 925.

In one example, the projected 3D coordinates may be converted into a depth value of the image plane pixel based on the 3D perspective projection relationship of the image sensor.

In a case where an image plane pixel among object pixels lacks a depth value, the depth value of the image plane pixel is calculated through warping in 930.

A depth value of a non-warped pixel is calculated through interpolation in 935.

In one example, in a case of an image plane pixel lacking a depth value, the depth value may be calculated using warping by Equation 7.

The low-resolution depth data is upsampled to high-resolution depth data that has the same resolution and projection relationship as those of the high-resolution image data in 940.

In one example, the calculated depth value of each pixel is designated to each pixel on a high-resolution image plane, and low-resolution depth data is upsampled to high-resolution depth data using a joint-bilateral filter that takes into account a brightness value of high-resolution image data and a distance between pixels, wherein the high-resolution depth data have the same resolution and projection relationship as those of the high-resolution image data.

The joint bilateral filtering may be implemented by Equation 5, and w(x_{I},y_{I}) of Equation 5, which is a joint-bilateral weight, may be calculated by Equation 6.

The upsampled high-resolution depth data is fused with the high-resolution image data to yield high-resolution fused data in 945.

In one example, the low-resolution depth data may be upsampled to high-resolution depth data that has the same resolution and projection relationship as those of the high-resolution image data, and the upsampled high-resolution depth data may be fused with the high-resolution image data to produce high-resolution fused data.

A correspondence point between a current frame and a subsequent frame of the object pixel is tracked in 950.

In one example, a correspondence point between a current frame and a subsequent frame of an object pixel may be tracked using constraints of constancy of image value.

The tracking of the correspondence point may be performed by calculating a correspondence point x_{I}^{t+1} on a subsequent frame I^{t+1} of the object pixel that minimizes a difference in image value, wherein the object pixel is located at position x_{I}^{t} on a current frame I^{t}, as shown in Equation 3.

A 3D position and angle of each joint of the skeletal model of the object is tracked in 955.

In one example, depth information of an object pixel and area information of the object, and correspondence point information may be received, and a 3D position and angle of each joint of the object skeletal model may be tracked by taking into consideration a hierarchical structure and kinematic chain of the skeletal model.

In this case, 3D position x_{I}^{t,i} of a pixel allocated to an i-th area in a current frame may correspond to 3D position X_{I}^{t+1,i} on a subsequent frame which may be based on a motion of joint Jᵢ in the i-th area and hierarchical structure and kinematic chain of the skeletal model. The 3D position X_{I}^{t+1,i} on the subsequent frame may be calculated by Equation 4 as shown above.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for tracking a motion using a hybrid camera, the apparatus comprising:
a data collecting part configured to obtain high-resolution image data and low-resolution depth data of an object;
a data fusion part configured to warp the obtained low-resolution depth data to a same image plane as that of the high-resolution image data, and fuse the high-resolution image data with high-resolution depth data upsampled from the low-resolution depth data on a pixel-by-pixel basis to produce high-resolution fused data;
a data partitioning part configured to partition the high-resolution fused data by pixel and distinguish between object pixels and background pixels, wherein the object pixels represent the object and the background pixels represent a background of an object image, and partition all object pixels into object-part groups using depth values of the object pixels;
a correspondence point tracking part configured to track a correspondence point between a current frame and a subsequent frame of the object pixel; and
a joint tracking part configured to track a 3-dimensional (3D) position and angle of each joint of a skeletal model of the object, in consideration of a hierarchical structure and kinematic chain of the skeletal model, by using received depth information of the object pixels, information about an object part, and correspondence point information.

2. The apparatus of claim 1, wherein the data collecting part uses one high-resolution image information collecting device to obtain the high-resolution image data, and one low-resolution image information collecting device to obtain the low-resolution depth data.

3. The apparatus of claim 1, wherein the data fusion part comprises:
a depth value calculator configured to convert depth data of the object into a 3D coordinate value using intrinsic and extrinsic parameters contained in the obtained high-resolution image data and low-resolution depth data, project the 3D coordinate value onto an image plane, calculate a depth value of a corresponding pixel on the image plane based on the projected 3D coordinate value, and when an object pixel lacks a calculated depth value, calculate a depth value of the object pixel through warping or interpolation, so as to obtain a depth value of each pixel;
an up-sampler configured to designate the calculated depth value to each pixel on an image plane and upsample the low-resolution depth data to the high-resolution depth data using joint-bilateral filtering that takes into consideration a brightness value of the high-resolution image data and distances between the pixels, wherein the upsampled high-resolution depth data has the same resolution and projection relationship as those of the high-resolution image data; and
a fused data generator configured to fuse the upsampled high-resolution depth data with the high-resolution image data to produce the high-resolution fused data.

4. The apparatus of claim 3, wherein the depth value calculator comprises
a 3D coordinate value converter configured to convert the depth data of the object into the 3D coordinate value using the intrinsic and extrinsic parameters contained in the high-resolution image data;
an image plane projector configured to project a 3D coordinate value of a depth data pixel onto an image plane of an image sensor by applying 3D perspective projection using intrinsic and extrinsic parameters of the low-resolution depth data; and
a pixel depth value calculator configured to convert the projected 3D coordinate value into the depth value of the corresponding image plane pixel based on a 3D perspective projection relationship, and when an image plane pixel among image pixels representing the object lacks a depth value, calculate a depth value of the image plane pixel through warping or interpolation.

5. The apparatus of claim 4, wherein the pixel depth value calculator comprises
a converter configured to convert the projected 3D coordinate value into the depth value of the corresponding image plane pixel based on the 3D perspective projection relationship of the image sensor;
a warping part configured to, when the image plane pixel among the image pixels lacks a depth value, calculate the depth value of the image plane pixel through warping; and
an interpolator configured to calculate a depth value of a non-warped pixel by collecting depth values of four or more peripheral pixels around the non-warped pixel and compute an approximate value of the depth value of the non-warped pixel through interpolation.

6. The apparatus of claim 1, wherein the data partitioning part divides the produced high-resolution fused data by pixel, distinguishes between the object pixels and the background pixels from the high-resolution fused data, calculates a shortest distance from each object pixel to a bone that connects joints of the skeletal model of the object by using depth values of the object pixels, and partitions all object pixels into different body part groups based on the calculated shortest distance.

7. The apparatus of claim 1, wherein the data partitioning part partitions the object pixels and the background pixels into different object part groups by numerically or statistically analyzing a difference in image value between the object and the background pixels, numerically or statistically analyzing a difference in depth value between the object and the background pixels, or numerically or statistically analyzing difference in both image value and depth value between the object and the background pixel.

8. A method for tracking a motion using a hybrid camera, the method comprising:
obtaining high-resolution image data and low-resolution depth data of an object;
warping the obtained low-resolution depth data to a same image plane as that of the high-resolution image data, and fusing the high-resolution image data with high-resolution depth data upsampled from the low-resolution depth data on a pixel-by-pixel basis to produce high-resolution fused data;
partitioning the high-resolution fused data by pixel and distinguishing between object pixels and background pixels wherein the object pixels represent the object and the background pixels represent a background of an object image, and partitioning all object pixels into object-part groups using depth values of the object pixels;
tracking a correspondence point between a current frame and a subsequent frame of the object pixel; and
tracking a 3-dimensional (3D) position and angle of each joint of a skeletal model of the object, in consideration of a hierarchical structure and kinematic chain of the skeletal model, by using received depth information of the object pixels, information about an object part, and correspondence point information.

9. The method of claim 8, wherein the obtaining of the high-resolution image data and the low-resolution depth data comprises obtaining the high-resolution image data and the low-resolution depth data using one high-resolution image information collecting device and one low-resolution depth information collecting device, respectively.

10. The method of claim 8, wherein the producing of the high-resolution fused data comprises:
converting depth data of the object into a 3D coordinate value using intrinsic and extrinsic parameters contained in the obtained high-resolution image data and low-resolution depth data, projecting the 3D coordinate value onto an image plane, calculating a depth value of a corresponding pixel on the image plane based on the projected 3D coordinate value, and when an object pixel lacks a calculated depth value, calculating a depth value of the object pixel through warping or interpolation, so as to obtain a depth value of each pixel;
designating the calculated depth value to each pixel on an image plane and upsampling the low-resolution depth data to the high-resolution depth data using joint-bilateral filtering that takes into consideration a brightness value of the high-resolution image data and distances between the pixels, wherein the upsampled high-resolution depth data has the same resolution and projection relationship as those of the high-resolution image data; and
fusing the upsampled high-resolution depth data with the high-resolution image data to produce the high-resolution fused data.

11. The method of claim 10, wherein the calculating of the depth value of the pixel comprises
converting the depth data of the object into the 3D coordinate value using the intrinsic and extrinsic parameters contained in the high-resolution image data;
projecting a 3D coordinate value of a depth data pixel onto an image plane of an image sensor by applying 3D perspective projection using intrinsic and extrinsic parameters of the low-resolution depth data; and
converting the projected 3D coordinate value into a depth value of the corresponding image plane pixel based on a 3D perspective projection relationship, and when an image plane pixel among image pixels representing the object lacks a depth value, calculating a depth value of the image plane pixel through warping or interpolation.

12. The method of claim 11, wherein the calculating of the depth value of the pixel comprises:
converting the projected 3D coordinate value into the depth value of the corresponding image plane pixel based on the 3D perspective projection relationship of the image sensor;
when the image plane pixel among the image pixels lacks a depth value, calculating the depth value of the image plane pixel through warping; and
calculating a depth value of a non-warped pixel by collecting depth values of four or more peripheral pixels around the non-warped pixel and computing an approximate value of the depth value of the non-warped pixel through interpolation.

13. The method of claim 8, wherein the partitioning of the pixels into the different body part groups comprises dividing the produced high-resolution fused data by pixel, distinguishing between the object pixels and the background pixels from the high-resolution fused data, calculating a shortest distance from each object pixel to a bone that connects joints of the skeletal model of the object by using depth values of the object pixels, and partitioning all object pixels into different body part groups based on the calculated shortest distance.

14. The method of claim 8, wherein the partitioning of the pixels into the different body part groups comprises partitioning the object pixels and the background pixels into different object part groups by numerically or statistically analyzing a difference in image value between the object and the background pixels, numerically or statistically analyzing a difference in depth value between the object and the background pixels, or numerically or statistically analyzing difference in both image value and depth value between the object and the background pixel.
